(19) United States
(12) Patent Application Publication
(10) Pub. No.: US 2013/0134105 A1
(43) Pub. Date: May 30, 2013

(54) LIGHT EXPANDED CLAY AGGREGATES FOR REMOVAL OF HALOGENATED CONTAMINANTS FROM WATER

(71) Applicant: Thomas Van Nooten, Ravels (BE)

(72) Inventor: Thomas Van Nooten, Ravels (BE)

(21) Appl. No.: 13/813,754

(22) PCT Filed: Jun. 26, 2011
(86) PCT No.: PCT/BE11/00051

§ 371 Date: Feb. 1, 2013

(30) Foreign Application Priority Data
Aug. 5, 2010 (BE) 2010/0479

(51) Int. Cl. C02F 1/70

(52) U.S. Cl. CPC C02F 1/705
USPC 210/747.4; 210/757; 210/747.8

(57) ABSTRACT

Light expanded clay aggregates are described that are prepared by firing and expanding a clay-based material, wherein metals such as palladium, copper or nickel are added to the clay together with iron prior to expansion and firing. The expanded clay aggregates can be used for cleaning of water contaminated with halogenated organic compounds. The latter are chemically degraded to harmless compounds in proximity of the added metals. The aggregates can be used as a reactive medium for treatment of contaminated groundwater, wastewater and landfill leachate.

### APPLICATION FIELD OF THE INVENTION

This invention relates to the development of reactive expanded clay aggregates for cleaning of water contaminated with chlorinated or halogenated organic compounds, including but not limited to solvents (e.g. tetrachloroethylene, trichloroethylene, trichloroethane, carbon tetrachloride, chloroform), pesticides (e.g. DDT), and polychlorinated biphenyls. The reactive aggregates are made by heating and expansion of a clay-based material, characterized in that prior to expansion and firing specific metals including but not limited to palladium, copper or nickel are added in small amounts to the clay. When the contaminated water is contacting the large internal reactive surface area of the porous aggregates, the halogenated compounds are reductively degraded in the proximity of tiny particles of the added metals and iron present in the aggregates. The added metals catalyze the degradation process of the halogenated compounds. The reactive clay aggregates can be used as a filling material (i) in so-called permeable reactive barriers for in-situ remediation of contaminated groundwater, (ii) in reactive drainage layers for treatment of landfill leachate, and (iii) in aboveground tanks and filters for treatment of pumped groundwater or wastewater.

### BACKGROUND OF THE INVENTION

Halogenated and more specifically chlorinated organic compounds are among the most widely occurring groundwater contaminants. Low molecular weight chlorinated hydrocarbons such as chloroform, dichloromethane, dichloroethene, and trichloroethane are effective solvents and are used in industrial cleaning applications including metal degreasing and dry cleaning. Introduction of these compounds into the subsurface, for instance due to accidental spills during processing or storage of these products (e.g. leaking pipes or storage tanks), can create serious soil and groundwater contamination. The compounds can be highly toxic and carcinogenic, and therefore only very low concentrations are permitted in groundwater. In addition to solvents, many pesticides including DDT and hexachlorocyclohexane contain chlorine atoms. Groundwater contamination with pesticides can occur due to agricultural pesticide use, spills at industrial production and storage facilities, and leakage of uncontrolled pesticide waste dumps.

Conventional groundwater remediation techniques usually involve extraction of the contaminated groundwater and pumping it over a tank filled with activated carbon. The contaminants are then removed from the water by adsorption onto the carbon. Volatile contaminants may also be removed from the water by air-stripping, whereby the resulting contaminated air can be subsequently cleaned by passage over activated carbon. A passive in-situ technology, termed ‘permeable reactive barrier’ was introduced in the nineties as an alternative approach to remediate groundwater contaminated with chlorinated hydrocarbons. U.S. Pat. No. 5,266,213 describes the installation of a permeable body of iron granules in the flow path of the groundwater contaminant plume. While the groundwater passively passes the iron granules (i.e. without the need for active groundwater pumping), the chlorinated hydrocarbons are degraded to harmless compounds due to reductive dechlorination reactions which are driven by electron transfer at the iron surface. Reductive dechlorination involves the replacement of chlorine atoms by hydrogen atoms coupled to electrons originating from oxidation of the iron.

As the reactions occur at the iron surface, degradation rates in the permeable reactive barriers are depending on the surface area of the iron granules exposed to the groundwater. The larger the surface area, the shorter the residence period that the groundwater needs to spend in the iron body to obtain a complete removal of the chlorinated hydrocarbons, and the lower the bulk mass of iron that is needed in the barrier. Using fine iron particles, thus obtaining a large surface area and so great reactivity, will however reduce the hydraulic properties (permeability) of the iron body. The latter is highly critical to the success of permeable reactive barriers as this technology relies on the natural groundwater flow through the iron body. The iron body therefore needs to remain a hydraulic conductivity that is substantially higher than the surrounding aquifer material to avoid that the contaminated groundwater is flowing around instead of through the barrier, not being remediated. As a consequence, coarse iron granules in the form of iron filings or cuttings are used. However, even then, the hydraulic properties of the iron body have often been reported to be drastically reduced during operation, due to precipitation of iron minerals (e.g. iron oxides, iron carbonates) and other minerals (e.g. calcium carbonate) causing cementation of the iron granules and disfunctioning of the remediation system. Particularly due to the long operational period that is intended for this passive technology (>10 years to several decades) and due to the fact that the technology is only cost-effective for long remediation periods, it is essential that a good permeability of the iron body is maintained during the complete duration.

Another method to substantially increase the degradation rates involves coating of the iron granules with small amounts of nickel as described in U.S. Pat. No. 6,287,472, whereby nickel catalyzes the reductive dechlorination reactions.

Light expanded clay aggregates are known to have highly favourable hydraulic properties and are therefore often used in drainage layers. The material is manufactured by a process wherein clay pellets are fired in a rotary kiln where they are expanded at a temperature increasing up to about 1200° C. The resulting ball-shaped granulates normally have a diameter within the range of about 0 to 32 mm. The granulates consist of a ceramic shell around a porous core with a large specific internal surface area in the form of tiny internal cavities which are interconnected. The granulates contain a certain amount of iron due to the presence of iron-containing minerals in the clay material that is used. In addition, iron is sometimes added and mixed with the clay in the form of iron oxides to enhance expansion of the clay during the firing process. Powdered metallurgical waste products can be used as a cheap source of iron (oxides).

### DESCRIPTION OF THE INVENTION

It is an object of the present invention to develop a granulate that is substantially reactive towards halogenated organic compounds, whilst having the desirable hydraulic properties and internal surface area as common expanded clay aggregates. According to the invention, this is achieved by preparing the aggregates in essentially the same way as common expanded clay aggregates, except that specific metals (e.g. palladium, copper, nickel) are added to the clay prior to the firing and expansion process. The specific metals are spread together with the iron as tiny metal particles over the large internal surface of the finished aggregates and provide a very large reactivity towards halogenated organic compounds. The ceramic matrix structure affords the reactive granulates the strength to ensure that the material retains its hydraulic conductivity. In this way, a very intimate contact between the groundwater and the reactive substances in the matrix can be retained during long-term applications such as permeable reactive barrier operations, whereby the halogenated organic contaminants are degraded due to the earlier described reductive processes. To ensure that the internal reactive surface area of the granulates is fully accessible to the contaminated water, the granulates are preferably cracked prior to use. The cracked granulate pieces still have a sufficiently large particle size (preferably 1 to 10 mm) to ensure a high hydraulic conductivity of the material.

In addition to their use in permeable reactive barriers, the reactive aggregates can be used as a reactive filling medium in aboveground tanks, vessels, filters and reactors for the treatment of pumped groundwater. The material is a.o. suited for fixed-bed reactor configurations, but due to their light weight character also for fluidized-bed reactor configurations. Similar to the treatment of pumped groundwater, wastewater streams containing halogenated compounds (e.g. AOX, EOX) or azo compounds (e.g. colorants) can be treated. Due to their excellent hydraulic characteristics, the reactive granulates can also be used to create reactive drainage layers at landfills. Active landfills generate huge amounts of landfill leachate due to infiltration of rain water and moisture release from the waste. Nowadays, landfills therefore have to be equipped with impermeable bottom liners and a drainage layer for proper collection of the leachate. Instead of a common drainage layer, the reactive granulates can be used to create a drainage layer that at the same time degrades the contaminants in the drained landfill leachate. Such an application would be particularly useful in landfills collecting chemical waste containing halogenated compounds (e.g. pesticide waste dumps). Similarly, reactive drainage layers can be applied at sludge and sediment disposal sites where the dredged material is often contaminated with chlorinated compounds and where a good sludge dewatering is critical to reduce the total sludge volume. Contaminated sediments can also be treated in-situ by capping them with a permeable cover filled with the reactive granulates. In this way, halogenated compounds that are released from the sediments first pass the reactive cover layer where they are degraded, avoiding contamination of the surface water.

What is claimed is:

1. A process for removing halogenated or chlorinated organic compounds from water, said process comprising the steps of:
a) mixing a clay-based material with one or more metals to form a mixture;
b) introducing the mixture into a rotary kiln to form pellets;
c) firing and expanding the pellets thereby producing light expanded clay aggregates;
d) contacting the light expanded clay aggregates with the contaminated water.

2. The process according to claim 1, wherein the added metal is iron, added in the form of iron oxides or other iron-containing minerals.

3. The process according to claim 2, wherein metallurgical waste products are used as the iron-containing material.

4. The process according to claims 2 to 3, wherein the amount of the iron added is 5 to 25% by weight of the total mixture.

5. The process according to claims 2 to 4, wherein a second metal other than iron is added.

6. The process according to claim 5, wherein the second non-iron metal is palladium.

7. The process according to claim 5, wherein the second non-iron metal is nickel.

8. The process according to claim 5, wherein the second non-iron metal is copper.

9. The process according to claim 5, wherein the second non-iron metal is platinum.

10. The process according to claim 5, wherein another non-iron metal than palladium, nickel, copper or platinum is added.

11. The process according to claims 2 to 4, wherein next to iron a mixture of different metals is added.

12. The process according to claims 5 to 11, wherein the non-iron metal is added in the form of a metal salt.

13. The process according to claims 5 to 11, wherein the non-iron metal is added in the form of a metal alloy.

14. The process according to claims 5 to 11, wherein the non-iron metal is added in the form of another metal-containing material.

15. The process according to claims 5 to 14, wherein the amount of the non-iron metal added is 0.005 to 0.05% by weight of the amount of iron added.

16. The process according to claims 5 to 14, wherein the amount of the non-iron metal added is 0.05 to 1% by weight of the amount of iron added.

17. The process according to claims 1 to 16, wherein the expanded clay aggregates are broken down to particles with a size of 1 to 10 mm to ensure that the internal reactive surface area of the aggregates is maximally accessible to the contaminated water.

18. The process according to claims 1 to 17, wherein the expanded clay aggregates are installed in the subsurface as a reactive matrix in such a way that the matrix is permeable for the contaminated groundwater (permeable reactive barrier).

19. The process according to claim 18, wherein the expanded clay aggregates are installed as a filling material in a trench in the subsurface.

20. The process according to claim 18, wherein the expanded clay aggregates are installed as a filling material in a subsurface tank.

21. The process according to claims 18 to 20, wherein the reactive matrix (permeable reactive barrier) is flanked at either sides by impermeable barriers which funnel the groundwater through the permeable matrix (funnel-and-gate principle).

22. The process according to claims 1 to 17, wherein the expanded clay aggregates are used as a filling material in an aboveground tank, reactor, filter or vessel for the treatment of pumped groundwater or wastewater.

23. The process according to claims 1 to 17, wherein the expanded clay aggregates are used to create reactive drainage layers at landfills, which degrade the contaminants in the drained landfill leachate.

24. The process according to claim 23, wherein the reactive drainage layer is applied at (dredging) sludge and sediment disposal sites

25. The process according to claims 1 to 17, wherein the expanded clay aggregates are used as a filling material in a permeable cover layer for capping of contaminated sediments in surface water bodies, in such a way that halogenated compounds that are released from the sediments first pass the reactive cover layer where they are degraded, avoiding contamination of the surface water.

26. The process according to claims 1 to 25, wherein the expanded clay aggregates are used for removal of other susceptible compounds from water, including azo compounds (colorants), nitroaromatic compounds, nitrate and metal contaminations.
